(19) United States
(12) Patent Application Publication
(10) Pub. No.: US 2007/0146781 A1
(43) Pub. Date: Jun. 28, 2007

(54) METHOD AND IMPLEMENTATION OF CAPTURING PRINT DATA FROM HETEROGENEOUS NETWORKED CLIENTS

(76) Inventor: Man Mohan GARG, Cerritos, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/677,924

(22) Filed: Feb. 22, 2007

Related U.S. Application Data
(63) Continuation-in-part of application No. 10/156,507, filed on May 28, 2002.

(51) Int. Cl. G06F 3/12

(52) U.S. Cl. 358/1.15

(57) ABSTRACT

The subject application is directed to a method and implementation of spooling electronic documents in a networked document processing environment. A print job is generated from a network client. A runtime printing component is plugged into a networking layer for a network client. Print data is captured from the print job in chunks using the continue printing component. The captured data is fed to a printer controller of a printing system without involving a native print system of a network operating system.

### CROSS-REFERENCE TO RELATED APPLICATIONS

This application is a continuation-in-part of U.S. patent application Ser. No. 10/156,507 filed on May 28, 2002.

### BACKGROUND OF THE INVENTION

The subject application is directed to a system and method for spooling of electronic documents in a networked document processing environment. More particularly, the subject application is directed to a system and method for spooling electronic documents in network printing wherein a number of clients and network servers employ a variety of different operating systems.

Many network servers operate with UNIX or WINDOWS-based operating systems. In addition, Linux-based systems are becoming increasingly popular operating systems for a variety of network systems. Interfacing a Linux network with various types of client machines requires the network to connect and receive print requests and data from all types of client operating systems, not just those client devices employing a Linux-based operating system. Thus, the Linux-based network relies on the network layer capturing the print data and then delivering the print data to the print system, e.g., a document processing device.

### SUMMARY OF THE INVENTION

In accordance with one embodiment of the subject application, there is provided a system and method for spooling of electronic documents in a networked document processing environment.

Further, in accordance with one embodiment of the subject application, there is provided a system and method for alleviating incompatibility between client operating systems and Linux-based networks so as to prevent loose data-links between a document processing systems and network connectivity.

Still further, in accordance with one embodiment of the subject application, there is provided a system and method for preventing a loss of client information between a Linux-based network and a client operating system.

Still further, in accordance with one embodiment of the subject application, there is provided a system and method for eliminating the bottleneck in data flow between a network layer and a client device using different operating environments.

Still further, in accordance with one embodiment of the subject application, there is provided a system and method for spooling electronic documents in network printing wherein a number of clients and network servers employ a variety of different operating systems.

Further, in accordance with one embodiment of the subject application, there is provided a system for spooling of electronic documents in a networked document processing environment. The system comprises a network layer and a runtime loadable, pluggable printing component. The network layer includes means adapted for communicating data with networked clients having a plurality of different operating system environments, invoking means adapted for invoking a printing component prior to receipt of an associated electronic document from a networked client, means adapted for relaying data chunks comprising the electronic document to the printing component, after invocation thereof, in accordance with received pointer data, and means adapted for communicating job status data to the networked clients in accordance with received pointer data. The runtime loadable, pluggable printing component including means adapted for publishing a printing interface to the network layer, means adapted for commencement of a print job processing upon receipt of an invocation from the network layer, means adapted for receiving data chunks comprising the electronic document from the network layer, means adapted for generating pointer data corresponding to received data chunks, means adapted for communicating pointer data to the network layer, and means adapted for communicating a received electronic document to a print spooler of an associated document processing controller. Incoming electronic documents are communicated from the network layer to the associated document processing controller via the printing component.

In one embodiment of the subject application, the invoking means further includes means adapted for dynamically loading symbols from an associated library so as to invoke the printing component. In this embodiment, the network layer and the printing component reside on a Linux platform, wherein the invoking means dynamically loads symbols form the associated library through a call to a dlopen/dlsym function.

In another embodiment of the subject application, the plurality of client different operating environments are from the set comprising UNIX, Linux, WINDOWS, and Solaris.

Still further, in accordance with one embodiment of the subject application, there is provided a method for spooling of electronic documents in a networked document processing environment in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for spooling of electronic documents in a networked document processing environment according to one embodiment of the subject application;

FIG. 2 is a block diagram illustrating interactions between elements of a spooling of electronic documents in a networked document processing environment according to one embodiment of the subject application;

FIG. 3 is a block diagram illustrating controller hardware for use in the system for spooling of electronic documents in a networked document processing environment according to one embodiment of the subject application;

FIG. 4 is a functional diagram illustrating the controller for use in the system for spooling of electronic documents in a networked document processing environment according to one embodiment of the subject application;

FIG. 5 is a flowchart illustrating a method for spooling of electronic documents in a networked document processing environment according to one embodiment of the subject application; and

FIG. 6 is a flowchart illustrating a method for spooling of electronic documents in a networked document processing environment according to one embodiment of the subject application.

### DETAILED DESCRIPTION OF THE PREFERRED EMBODIMENT

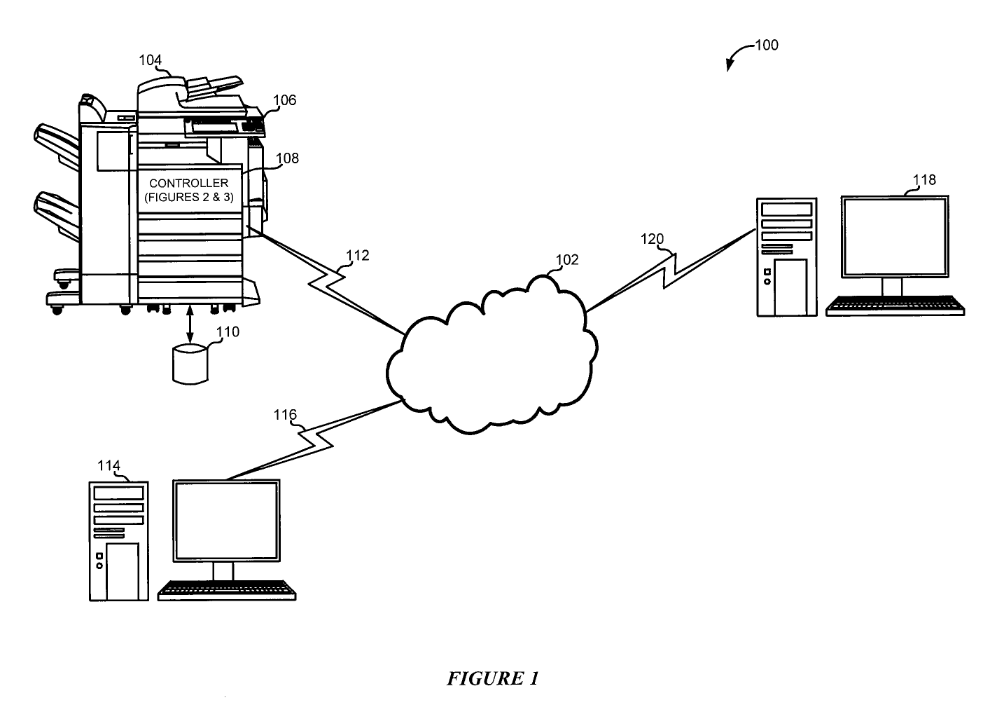

The subject application is directed to a system and method for spooling of electronic documents in a networked document processing environment. In particular, the subject application is directed to a system and method for spooling electronic documents in network printing wherein a number of clients and network servers employ a variety of different operating systems. More particularly, the subject application is directed to a system and method for alleviating incompatibility between client operating systems and Linux-based networks so as to prevent loose data-links between a document processing systems and network connectivity, which result in loss of client information. It will become apparent to those skilled in the art that the system and method described herein are suitably adapted to a plurality of varying electronic fields employing data communication between different operating environments, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for spooling of electronic documents in a networked document processing environment in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

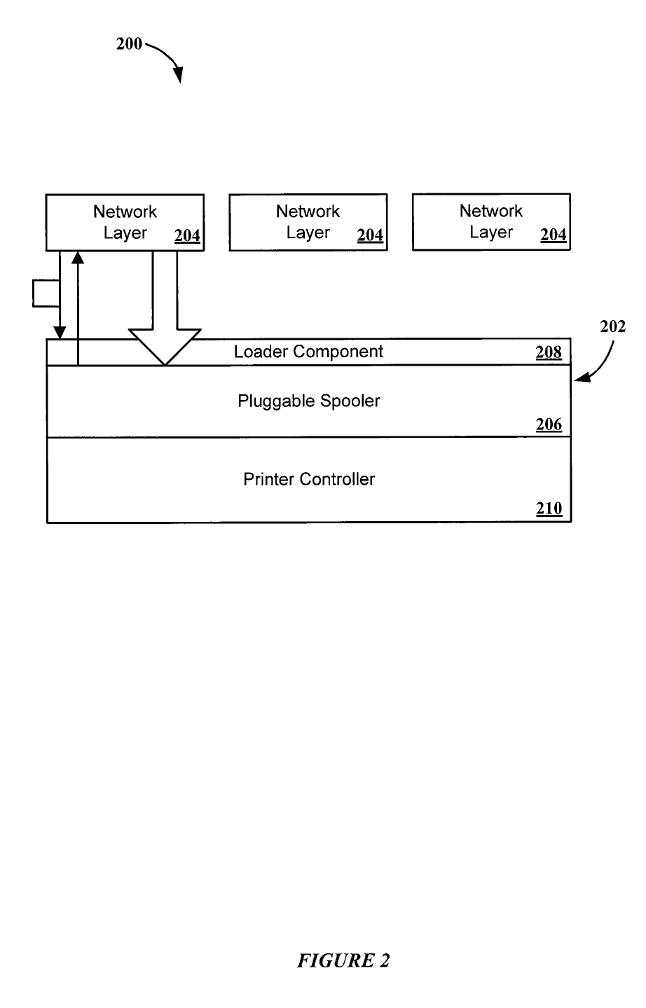

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for spooling of electronic documents in a networked document processing environment of the subject application. The functioning of the controller 108 will better be understood in conjunction with the block diagrams illustrated in FIGS. 2, 3, and 4, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116 and a user device 118 in data communications with the computer network 102 via a communications link 120. It will be appreciated by those skilled in the art that the user devices 114 and 118 are shown in FIG. 1 as personal computers for illustration purposes only. As will be understood by those skilled in the art, the user devices 114 and 118 are representative of any personal computing device known in the art, including, for example and without limitation, a computer workstation, a laptop computer, a personal data assistant, a web-enabled cellular telephone, a smart phone, a proprietary network device, or other web-enabled electronic device. The communications links 116 and 120 are any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user devices 114 and 118 are suitably adapted to generate and transmit electronic documents, document processing instructions, user interface modifications, upgrades, updates, personalization data, or the like, to the document processing device 104, or any other similar device coupled to the computer network 102. In accordance with one particular embodiment of the subject application, the user devices 114 and 118 employ different operating systems, e.g., WINDOWS, LINUX, UNIX, MAC OS, or the like.

Referring now to FIG. 2, there is shown a block diagram illustrating interactions between elements of subsystem 200 of the controller 108 for spooling of electronic documents in a networked document processing environment in accordance with one embodiment of the subject application. As illustrated in FIG. 2, the system 200 comprises a runtime pluggable printing component 202 that is capable of being plugged into the networking layers 204 of a network client, e.g., the document processing device 104. In accordance with a preferred embodiment of the subject application, the network layers 204 are configured to interact with different types of operating systems that client machines are running, e.g., WINDOWS, LINUX, UNIX, SOLARIS, etc. and provide a facility to the clients to submit documents for printing.

The pluggable component 202 further includes a pluggable spooler 206 that operates under the operating system of a network server, such as LINUX, though it will be understood by those skilled in the art that the subject application is capable of being adapted to for compatibility with any operating system known in the art. The pluggable spooler 206 delivers print documents to the printer controller 210 of a print system, whereupon hard copy documents are produced.

Networking layers 204 are suitably adapted for communicating data with networked clients, e.g., the document processing device 104. Multiple networking layers 204 are employed to enable data communications for a plurality of different operating system environments. For example and without limitation, different networking layers 204 are capable of being provided for clients operating with UNIX, LINUX, WINDOWS, SOLARIS, and the like. When a document is ready to print (or scanned, faxed and/or output in any manner), and before data transfer starts, the networking layer 204 corresponding to the operating system of the client (e.g., the document processing device 104, the user device 114, or the user device 118) sending the document invokes printing component 202. In an example embodiment, the invocation happens in the form of dynamically loading symbols from a shared library. This dynamic loading of symbols is effective to plug-in print services to the networking layers in the form of calls like CreatePrintJob, PushData, StartPage/EndPage, EndPrintJob along with job management services like GetJobsList, GetJoblnformation/Status, PauseJob, CancelJob etc. The pluggable component 202 is built from these loaded symbols. In one aspect, this can be carried out by calling one or more of a dlopen, dlsys function in LINUX. By building the pluggable component in this manner, it is suitable to plug the component with “open source” components without having to link with them.

After the pluggable component 202 is built, data transfer commences. The pluggable component 202 publishes a printing interface (e.g. loader component 208) to be used by networking layer 204 to deliver the print document to printer controller 210. Loader component 208 provides pointers between the networking layers 204 and the print spooler 206. By providing pointers between the networking layers 204 and print spooler 206, loader component 208 allows continuous processing of the document while it is being received by networking layer 204 enabling a data stream to flow continuously from a client machine (not shown) to the printer (via controller 210). Loader component 208 helps keep the printing system disjointed from the networking layers 204, thereby removing the need to link the printing spooler 206 with networking components. For example, pointers provided by loader component 208 enables networking layer 204 to relay data as it is being received to printer component 202. For example the entire document may not be received all at once by networking layer 204, instead portions (or chunks) of the document may be received by networking layer 204. Using the pointers provided by loader component 208 enables the “chunks” of the document to be forwarded by networking layer 204 to spooler 206 of printer component 202 as soon as the chunks are received by networking layer 204.

By using pointer provided by loader component 208, pluggable printing component 202 captures print data in chunks directly from the networking layers 204. The chunks are transferred from network layer 204 to print spooler 206 via the pointers provided by loader component 208. Print spooler 206 then feeds the chunks directly to the print controller 210 of the print system. Print spooler 206 interacts with the print system and could be loosely connected or linked to the print system. Thus, pluggable component 202 allows continuous processing of documents while the data chunks are being received, allowing the data stream to flow continuously from the client machine to the printer system, so that the print job starts processing without delay as the data arrives.

In an example embodiment, the present invention can also feed back a job status data to the client. Pointers provided by loader component 208 enables printer component 202 to provide job status data to network layer 204. Networking layer 204 employs the pointers received from loader component 208 to acquire job status information from spooler 206. Acquiring job status data enables networking layer 204 to communicate job status data to the network clients. In an example embodiment, providing job status data can be facilitated by modifying the code in network layer 204. These modifications are easily realized for most common network connectivity layers, e.g., using LINUX viz. SAMBA (for “WINDOWS” connectivity) and CUPS (Common UNIX Printing System) for connectivity with IPP (Internet Print Protocol). Other modifications can be contemplated without departing from the invention.

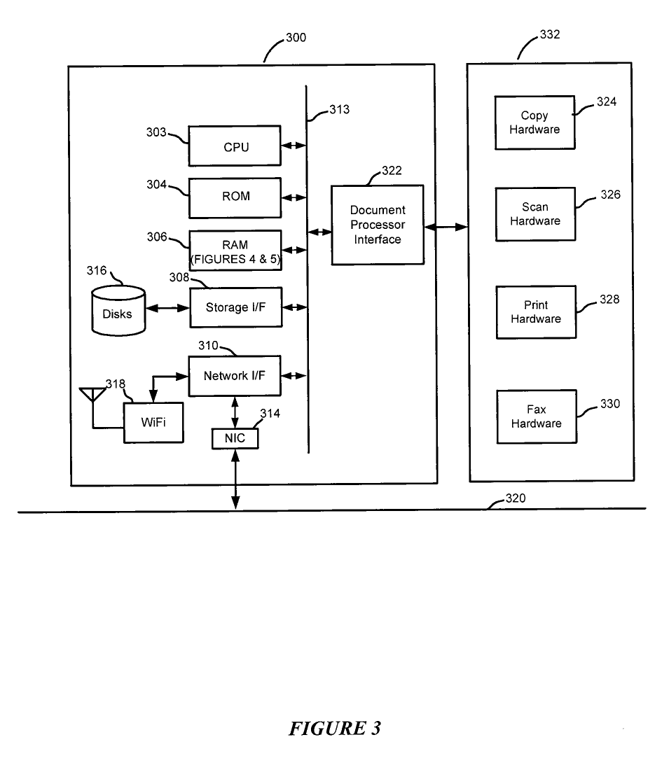

Turning now to FIG. 3, illustrated is a representative architecture of a suitable backend component, i.e., the controller 300, shown in FIG. 1 as the controller 108, on which operations of the subject system 100 are completed. The skilled artisan will understand that the controller 108 is representative of any general computing device, known in the art, capable of facilitating the methodologies described herein. Included is a processor 302, suitably comprised of a central processor unit. However, it will be appreciated that processor 302 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 300 is random access memory 306, suitably formed of dynamic random access memory, static random access memory, or any other suitable, addressable and writable memory system. Random access memory provides a storage area for data instructions associated with applications and data handling accomplished by processor 302.

A storage interface 308 suitably provides a mechanism for non-volatile, bulk or long term storage of data associated with the controller 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the controller 300 to communicate to other devices. The network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 314 is interconnected for data interchange via a physical network 320, suitably comprised of a local area network, wide area network, or a combination thereof.

Data communication between the processor 302, read only memory 204, random access memory 306, storage interface 308 and the network interface subsystem 310 is suitably accomplished via a bus data transfer mechanism, such as illustrated by bus 312.

Also in data communication with bus the 312 is a document processor interface 322. The document processor interface 322 suitably provides connection with hardware 332 to perform one or more document processing operations. Such operations include copying accomplished via copy hardware 324, scanning accomplished via scan hardware 326, printing accomplished via print hardware 328, and facsimile communication accomplished via facsimile hardware 330. It is to be appreciated that the controller 300 suitably operates any or all of the aforementioned document processing operations. Systems accomplishing more than one document processing operation are commonly referred to as multifunction peripherals or multifunction devices.

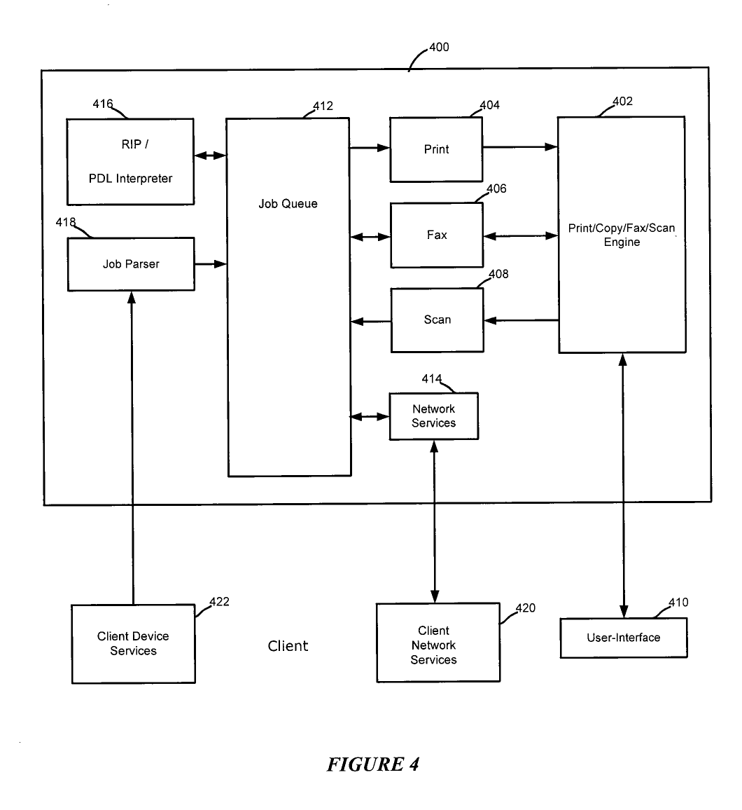

Functionality of the subject system 100 is accomplished on a suitable document processing device, such as the document processing device 104, which includes the controller 300 of FIG. 3, (shown in FIG. 1 as the controller 108) as an intelligent subsystem associated with a document processing device. In the illustration of FIG. 4, controller function 400 in the preferred embodiment, includes a document processing engine 402. A suitable controller functionality is that incorporated into the Toshiba e-Studio system in the preferred embodiment. FIG. 4 illustrates suitable functionality of the hardware of FIG. 3 in connection with software and operating system functionality as will be appreciated by one of ordinary skill in the art.

In the preferred embodiment, the engine 402 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 402 is suitably interfaced to a user interface panel 410, which panel allows for a user or administrator to access functionality controlled by the engine 402. Access is suitably enabled via an interface local to the controller, or remotely via a remote thin or thick client.

The engine 402 is in data communication with the print function 404, facsimile function 406, and scan function 408. These functions facilitate the actual operation of printing, facsimile transmission and reception, and document scanning for use in securing document images for copying or generating electronic versions.

A job queue 412 is suitably in data communication with the print function 404, facsimile function 406, and scan function 408. It will be appreciated that various image forms, such as bit map, page description language or vector format, and the like, are suitably relayed from the scan function 408 for subsequent handling via the job queue 412.

The job queue 412 is also in data communication with network services 414. In a preferred embodiment, job control, status data, or electronic document data is exchanged between the job queue 412 and the network services 414. Thus, suitable interface is provided for network based access to the controller function 400 via client side network services 420, which is any suitable thin or thick client. In the preferred embodiment, the web services access is suitably accomplished via a hypertext transfer protocol, file transfer protocol, uniform data diagram protocol, or any other suitable exchange mechanism. The network services 414 also advantageously supplies data interchange with client side services 420 for communication via FTP, electronic mail, TELNET, or the like. Thus, the controller function 300 facilitates output or receipt of electronic document and user information via various network access mechanisms.

The job queue 412 is also advantageously placed in data communication with an image processor 416. The image processor 416 is suitably a raster image process, page description language interpreter or any suitable mechanism for interchange of an electronic document to a format better suited for interchange with device functions such as print 404, facsimile 406 or scan 408.

Finally, the job queue 412 is in data communication with a parser 418, which parser suitably functions to receive print job language files from an external device, such as client device services 422. The client device services 422 suitably include printing, facsimile transmission, or other suitable input of an electronic document for which handling by the controller function 400 is advantageous. The Parser 418 functions to interpret a received electronic document file and relay it to the job queue 412 for handling in connection with the afore-described functionality and components.

In operation, data is first communicated, via a network layer, with networked clients having a plurality of different operating system environments. The network layer then invokes a printing component prior to the receipt of an electronic document from a networked client. The electronic document is then relayed as data chunks to the printing component via the network layer according to received pointer data. Job status data is then communicated to the networked clients via the network layer according to the received pointer data. A printing interface is then published to the network layer from a runtime loadable, pluggable printing component. Print job processing is then commenced upon receipt of an invocation from the network layer via the printing component. Data chunks corresponding to the electronic document are then received from the network layer by the printing component. Pointer data is then generated by the printing component corresponding to received data chunks. The pointer data is then communicated to the network layer via the printing component, whereupon a received electronic document is communicated from the printing component to a print spooler of an associated document processing controller.

According to one example embodiment of the subject application, a networked client device, such as the user device 114 or the user device 118, submits a document processing request, such as a print job, to the document processing device 104 via the computer network 102. Thereafter, the controller 108, or other suitable component associated with the document processing device 104, determines which of the available network layers 204 have been used by the originating client device, e.g., the user device 114 or the user device 118. Once the network layer 204 has been identified by the controller 108, symbols are dynamically loaded from a library, such as a library stored in the data storage device 110, corresponding to a printing component 202 associated with the identified network layer 204. This printing component 202 is then invoked so as to facilitate communication and processing of the requested document processing operation.

A printing interface is then published to the network layer 204 by the printing component 202. Preferably, this printing interface is published by a runtime loadable, pluggable printing component associated with the printing component 202. The controller 108 then directs the commencement of processing of the requested document processing operation. The commencement begins with the receipt of data chunks corresponding to an electronic document that is received by the component 202 via the network layer 204 from the user device 114, the user device 118, or the like. The printing component 202 then generates pointers corresponding to the received data chunks. The generated pointer data is then communicated back to the network layer 204 by the printing component 202. The network layer 204 then relays chunks of the electronic document to the printing component 202 based upon the receive pointer data. The electronic document, as represented by the received data chunks, is then communicated to the print spooler 206 of the controller 108. Thereafter, the controller 108, via the network layer 204, communicates job status data to the requesting client device, e.g., the user device 114 or the user device 118.

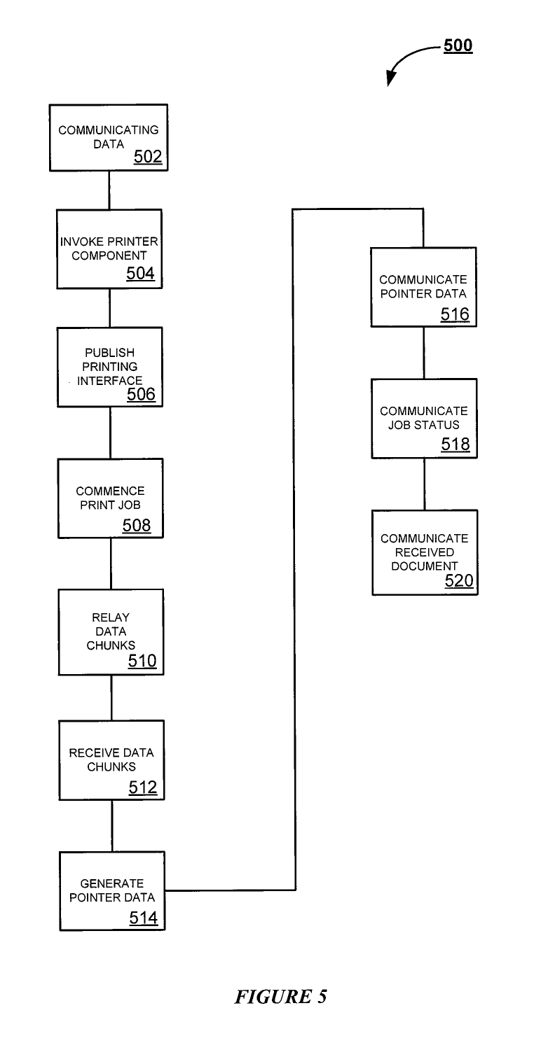

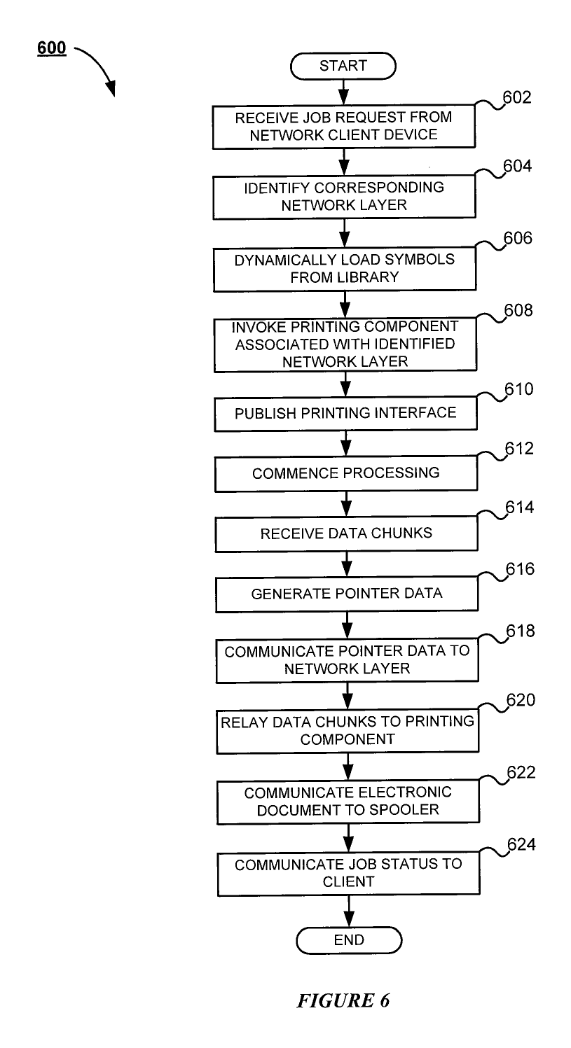

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for spooling of electronic documents in a networked document processing environment in accordance with one embodiment of the subject application. Beginning at step 502, data is communicated via a network layer 204, with networked clients having a plurality of operating system environments. At step 504, the network layer 204 invokes a printing component, such as printing component 202 depicted in FIG. 2. Preferably, the network layer 204 invokes the printing component prior to receipt of an associated electronic document from a networked client. In an example embodiment invoking the printing component includes dynamically loading symbols from an associated library. In accordance with such an example embodiment, the associated library is accessed through a call to either a dlopen, dlsym and/or dlopen/dlsym function on a Linux® platform.

At step 506, a printing interface is published to the network layer (for example loader component 208 of printer interface 202 is published to network layer 204. Loader component 208 delivers chunks (e.g. portions) of print documents from network layer 204 in FIG. 2 to spooler 206) from a runtime loadable, pluggable printing component (e.g. printing component 202 in FIG. 2). At step 508, the print job commences responsive to an invocation from the network layer via the printing component. For example in FIG. 2, a print job commences responsive to an invocation from network layer 204 via printing component 202.

At step 510, data chunks (e.g. portions of the associated document) from the associated electronic document are relayed to the printing component via the network layer 204. This occurs after invocation of the printing component and in accordance with received pointer data. At step 512, data chunks of the electronic document are received from the network layer 204 via the printing component. For example, referring to FIG. 2, this corresponds to data chunks being received by pluggable spooler 206 relayed via network layer 204. At step 514, pointer data is generated from the printing component 202. The pointer data corresponds to the received data chunks. At step 516, the pointer data is communicated to the network layer 204 via the printing component 10.

At step 518, job status data is communicated to the network clients. The data is communicated via the network layer 204 and in accordance with received pointer data from the printer component 202. Chunks of the document are relayed from the network layer 204 to the pluggable spooler 206, and from the pluggable spooler 206 to the associated document processor controller 210 until, at step 520, the received electronic document is communicated from the printing component 202 to the associated document processor controller 108.

Referring now to FIG. 6, there is shown a flowchart 600 illustrating a method for spooling of electronic documents in a networked document processing environment in accordance with one embodiment of the subject application. The flowchart 600 begins at step 602, whereupon a client device, such as the user device 114 or the user device 118, initiates a document processing operation via the transmission of a document processing request to the document processing device 102. Preferably, this transmission is accomplished via a suitable communications channel over the computer network 102. The controller 108, or other suitable component of the associated document processing device 104 then identifies, at step 604, which of the available network layers 204 the client device (114 or 118) used to transmit the job.

At step 606, the controller 108 directs the dynamic loading of symbols from an associated library corresponding to the identified network layer 204. A printing component 202 is then invoked at step 608 associated with the symbols loaded and corresponding to the identified network layer 204. The printing component 202 then publishes, at step 610, a printing interface to the identified network layer 204, so as to facilitate the communication of document processing operation data related to the document processing request. The controller 108, via input from the component 202, then commences the initialization of the processing operation at step 612, i.e., prepares to receive document data, output options, and the like. At step 614, data chunks are received from the client device (114 or 118) via the network layer 204 by the printing component 202, which generates corresponding pointer data at step 616.

The pointer data is then communicated to the network layer 204 at step 618. It will be understood by those skilled in the art that the pointer data is used to facilitate the destination, with respect to the printing component 202, for additional incoming data chunks, so as to provide smooth processing of the electronic document corresponding thereto. At step 620, the network layer 204 relays data chunks associated with the electronic document being processed to the printing component 202 based upon the pointer data. That is, as additional chunks of the document are received via the network layer 204, the chunks are forwarded to the destination of the printing component 202 indicated by the associated pointer data. The electronic document, e.g., the received data chunks, is then communicated at step 622 to a print spooler 206 of the controller 108, so as to facilitate output of the document in accordance with the requested operation. Thereafter, at step 624, the job status data is communicated by the controller 108, or a suitable component thereof, to the requesting client device, e.g., the user device 114 or the user device 118, via the identified network layer 204.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing device spooling system comprising:
a network layer including,
means adapted for communicating data with networked clients having a plurality of different operating system environments,
invoking means adapted for invoking a printing component prior to receipt of an associated electronic document from a networked client,
means adapted for relaying data chunks comprising the electronic document to the printing component, after invocation thereof, in accordance with received pointer data;
means adapted for communicating job status data to the networked clients in accordance with received pointer data; and
a runtime loadable, pluggable printing component including,
means adapted for publishing a printing interface to the network layer,
means adapted for commencement of a print job processing upon receipt of an invocation from the network layer,
means adapted for receiving data chunks comprising the electronic document from the network layer,
means adapted for generating pointer data corresponding to received data chunks,
means adapted for communicating pointer data to the network layer, and
means adapted for communicating a received electronic document to a print spooler of an associated document processing controller;
wherein incoming electronic documents are communicated from the network layer to the associated document processing controller via the printing component.

2. The document processing device spooling system of claim 1 wherein the invoking means includes means adapted for dynamically loading symbols from an associated library so as to invoke the printing component.

3. The document processing device spooling system of claim 2 wherein the network layer and the printing component reside on a Linux platform, and wherein the invoking means dynamically loads symbols from the associated library through a call to a dlopen/dlsym function.

4. The document processing device spooling system of claim 1 wherein the plurality of client different operating environments are from the set comprising UNIX, Linux, Windows and Solaris.

5. A method for spooling of electronic documents in a networked document processing environment comprising the steps of:
communicating, via a network layer, data with networked clients having a plurality of different operating system environments;
invoking, via the network layer, a printing component prior to receipt of an associated electronic document from a networked client;
relaying data chunks comprising the electronic document to the printing component via the network layer, after invocation thereof, in accordance with received pointer data;
communicating job status data, via the network layer, to the networked clients in accordance with received pointer data;
publishing a printing interface to the network layer from a runtime loadable, pluggable printing component via the printing component;
commencing a print job processing upon receipt of an invocation from the network layer via the printing component;
receiving data chunks comprising the electronic document from the network layer via the printing component;
generating pointer data from the printing component, which pointer data corresponds to received data chunks;
communicating pointer data to the network layer via the printing component; and
communicating a received electronic document from the printing component to a print spooler of an associated document processing controller.

6. The method of claim 5 further comprising the step of dynamically loading symbols from an associated library, via the network layer, so as to invoke the printing component.

7. The method of claim 6 further comprising the step of dynamically loading symbols from the associated library through a call to a dlopen/dlsym function via the network layer operating on a Linux platform.
